(19) United States
(12) Patent Application Publication
(10) Pub. No.: US 2017/0168628 A1
(43) Pub. Date: Jun. 15, 2017

(54) METHOD AND ELECTRONIC DEVICE FOR SPLIT-SCREEN DISPLAY

(71) Applicants: Le Holdings (Beijing) Co., Ltd., Beijing (CN); LE SHI INTERNET INFORMATION & TECHNOLOGY CORP. BEIJING, Beijing (CN)

(72) Inventor: Fei YIN, Beijing (CN)

(21) Appl. No.: 15/250,637

(22) Filed: Aug. 29, 2016

Related U.S. Application Data
(63) Continuation of application No. PCT/CN2016/089054, filed on Jul. 7, 2016.

(30) Foreign Application Priority Data
Dec. 15, 2015 (CN) 201510938567.8

(51) Int. Cl. G06F 3/041; G06F 3/0481

(52) U.S. Cl. CPC G06F 3/0414; G06F 3/0481; G06F 2203/04803

(57) ABSTRACT

A method and an electronic device for split-screen display are disclosed, wherein the method includes: dividing a display screen of a mobile terminal into a first display region and a second display region in response to a split-screen display instruction; displaying an interface of a currently-running application in the first display region; judging whether a press operation applied to an application receiving an event notification satisfies a preset condition; and when the press operation applied to the application receiving an event notification satisfies the preset condition, displaying an interface of the application receiving an event notification in the second display region.

### CROSS REFERENCE TO RELATED APPLICATIONS

This present disclosure is a continuation of International Disclosure No. PCT/CN2016/089054, filed on Jul. 7, 2016, which is based upon and claims priority to Chinese Patent Disclosure No. 201510938567.8, filed on Dec. 15, 2015, the entire contents of which are incorporated herein by reference.

### TECHNICAL FIELD

The present disclosure relates to the field of mobile communication technologies, and more particularly, to a method and an electronic device for split-screen display.

### BACKGROUND

With the development of electronic technologies, more and more functions (e.g., functions achieved through operating systems or applications installed) are achieved by various terminals (e.g., mobile phones, tablets, personal computers, game machines, multimedia players, etc.) Accordingly, screen sizes of the terminals are increasingly enlarged, and touch functions are also more and more sensitive, such that people can use the terminals conveniently.

Taking the mobile phone for example, people may browse information on the internet through a browser loaded in the mobile phone, communicate with the outside world through a conversation application loaded in the mobile phone, and interact information with the outside world through an instant messaging application of the mobile phone.

Because the terminal has more and more functions, the user can handle more and more matters when using the mobile terminal. For example, the user may perform voice communication through the mobile terminal, and may also watch videos, receive short massages, play games, etc. With the continuously enriched functions, a process using the mobile terminal by the user may be affected by other applications unavoidably. For example, when playing games, the user may receive a short massage or receive push notifications of other applications. At this moment, a game interface displayed in a display screen of the mobile terminal needs to be switched to a massage interface or interfaces of other applications in case of viewing the short massage or the push notifications of other applications. After viewing relevant information, the user further needs to switch the interface displayed in the display screen of the mobile terminal to the game interface again. Such an operating process is complicated undoubtedly. In addition, the process of a game or a video may be interrupt automatically while switching the applications, resulting in that a game program or a video program will be restarted. Then, a previous progress cannot be continued to play the game or watch the video even when the user switches the interface to the game interface or video interface, which brings very bad use experience to the user.

With respect to the foregoing situations, a method for performing split-screen display on the mobile terminal has been proposed. When implementing the split-screen display function, most existing mobile terminals divide a screen into several regions according to a slide trace of the user firstly, and then drag applications available for split-screen to each region respectively to implement split-screen display; or the user selects the applications available for split-screen firstly, and then split-screen display is performed on the plurality of applications selected according to a preset split-screen rule. However, these split-screen display implementation methods have tedious steps, are complicated to operate, and are not beneficial for improving the user experience of the mobile terminal product.

### SUMMARY

Embodiments of the present disclosure provide a method and an electronic device for split-screen display, which can implement split-screen display of applications on the mobile terminal conveniently, so as to improve the use experience of users.

An embodiment of the present disclosure provides a method for split-screen display, including: dividing a display screen of a mobile terminal into a first display region and a second display region in response to a split-screen display instruction; displaying an interface of a currently-running application in the first display region; judging whether a press operation applied to an application receiving an event notification satisfies a preset condition; and when the press operation applied to the application receiving an event notification satisfies the preset condition, displaying an interface of the application receiving an event notification in the second display region.

An embodiment of the present disclosure further provides an electronic device, including: at least one processor; and a memory communicably connected with the at least one processor for storing instructions executable by the at least one processor, wherein execution of the instructions by the at least one processor causes the at least one processor to:

divide a display screen of a mobile terminal into a first display region and a second display region in response to a split-screen display instruction; display an interface of a currently-running application in the first display region; judge whether a press operation applied to an application receiving an event notification satisfies a preset condition; and when the press operation applied to the application receiving an event notification satisfies the preset condition, display an interface of the application receiving an event notification in the second display region.

An embodiment of the present disclosure further provides a non-transitory computer-readable storage medium storing executable instructions that, when executed by an electronic device with a touch-sensitive display, cause the electronic device to: divide a display screen of a mobile terminal into a first display region and a second display region in response to a split-screen display instruction; display an interface of a currently-running application in the first display region; judge whether a press operation applied to an application receiving an event notification satisfies a preset condition; and when the press operation applied to the application receiving an event notification satisfies the preset condition, display an interface of the application receiving an event notification in the second display region.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for split-screen display according to the embodiment of the present disclosure; and

FIG. 2 is a diagram illustrating functional modules of a mobile terminal for split-screen display according to the embodiment of the present disclosure.

FIG. 3 is a schematic structural diagram illustrating an electronic device according to the present disclosure.

### DETAILED DESCRIPTION

To make the objectives, technical solutions, and advantages of the present disclosure clearer, the technical solutions of the present disclosure will be clearly and completely described hereinafter with reference to the accompanying drawings of the present disclosure. Apparently, the embodiments described are merely partial embodiments of the present disclosure, rather than all embodiments. Other embodiments derived by persons of ordinary skill in the art on the basis of the embodiments of the present disclosure without going through creative efforts shall all fall within the protection scope of the present disclosure.

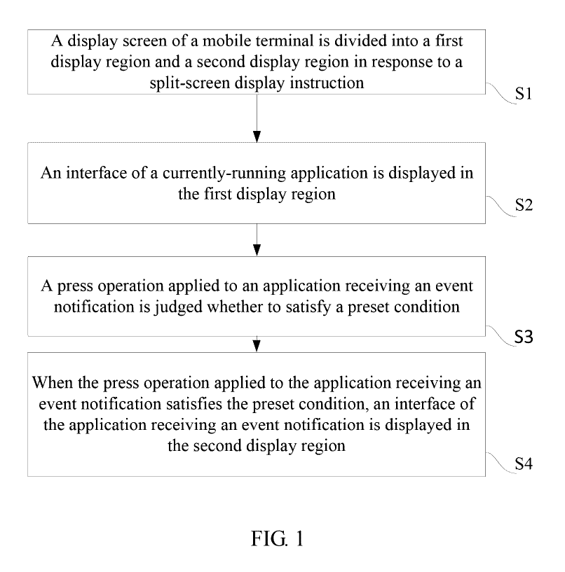

FIG. 1 is a flowchart illustrating a method for split-screen display according to the embodiment of the present disclosure. Although the processes described herein comprise a plurality of operations in a specific sequence, it should be clearly understood that, these processes may comprise more or fewer operations, while these operations may be performed in sequence or performed concurrently (e.g., using a parallel processor or multi-thread environment). As illustrated in FIG. 1, the method may include the following steps:

In step S1, a display screen of a mobile terminal is divided into a first display region and a second display region in response to a split-screen display instruction.

In the embodiment of the present disclosure, the split-screen display function may either be preset inside the mobile terminal, or be acquired through downloading a corresponding application. The split-screen display function may be corresponding to the split-screen display instruction. When the split-screen display instruction is not triggered, then the mobile terminal may display the application currently run through the display screen of the mobile terminal in a full screen manner like a mobile terminal in the prior art. While when the split-screen display instruction is triggered, then the display screen of the mobile terminal may be divided into the first display region and the second display region. The first display region and the second display region may not be overlapped mutually to assure independence of display contents therein.

Before dividing the display regions, a split-screen display mode of the display screen of the mobile terminal may be preset in the embodiment of the present disclosure. The split-screen display mode, for example, may include up and down split-screen display or left and right split-screen display. The display screen of the mobile terminal may be divided into a display region consistent with the split-screen display mode according to the split-screen display mode. For example, the display screen of the mobile terminal may be divided into a first display region and a second display region which have the same size and are distributed up and down. Certainly, the display screen of the mobile terminal may further be divided into a first display region and a second display region which have different sizes and are distributed left and right.

In the embodiment of the present disclosure, a liquid crystal display layer in the display screen of the mobile terminal may be controlled through a drive program. Display crystals distributed in the liquid crystal display layer may be controlled according to a preset split-screen display mode. For example, coordinate systems of the display crystals in the liquid crystal display layer may be divided to distribute a unique coordinate for each display crystal. In this way, the display crystals in the liquid crystal display layer may be divided into crystals attributed to the first display region and crystals attributed to the second display region according to the preset split-screen display mode. The division is based on a range of a coordinate system covered by the first display region and a range of a coordinate system covered by the second display region. Display crystals in the range of the coordinate system may be divided into a corresponding display region through the range of the coordinate system covered. In this way, when the interface of the application needs to be displayed in the divided display region, the display crystals may be controlled to emit light through the drive program, thus displaying the interface in the display region to a user.

Moreover, luminance of the first display region and luminance of the second display region may be controlled separately or globally. When the luminance of the first display region and the luminance of the second display region are controlled separately, the display crystals corresponding to the first display region and the display crystals corresponding to the second display region may be driven respectively, such that the luminance of the two display regions may be regulated separately. Certainly, the luminance of all the display crystals may be changed simultaneously by controlling all the display crystals globally, such that the luminance of the display region may be changed uniformly.

In step S2, an interface of a currently-running application is displayed in the first display region.

Upon dividing the display screen of the mobile terminal into the first display region and the second display region, the interface of the currently-running application in the mobile terminal may be displayed in the first display region, so as to provide discontinuous visual experience. For example, the user receives an event notification sent from AliPay suddenly while playing games. At this moment, the user wants to view the event notification of AliPay simultaneously while playing games, then the user may trigger a split-screen display instruction. Upon receiving the split-screen display instruction, the mobile terminal may divide the display screen into a first display region and a second display region, and display a game interface in the first display region, such that the game interface will not be switched, but is continuously displayed in the display screen of the mobile terminal.

At this moment, an icon of an application receiving an event notification may be displayed in the second display region for the user to select. It should be noted that in a certain time period, the mobile terminal may receive event notifications from a plurality of applications simultaneously or successively. For example, the user successively receives event notifications from AliPay, short messages, weather and WeChat successively while playing games. Then, icons of these different applications may all be arranged in the second display region according to a preset sequence at this moment, so as to remind the user that which applications have event notifications at current, thus being convenient for the user to select specifically.

In step S3, a press operation applied to an application receiving an event notification is judged whether to satisfy a preset condition.

Upon displaying the application receiving an event notification to the user, the user may perform a press operation on an icon of an application expected to view. In this way, the mobile terminal may detect a press operation applied to these applications and judge whether the press operation satisfies the preset condition.

Presently, because display screens of partial mobile terminals can induce a pressing strength of the user, the press operation may be judged whether to satisfy the preset condition according to the pressure corresponding to the press operation in a specific embodiment of the present disclosure. Firstly, a preset pressure threshold corresponding to the press operation may be determined in the embodiment of the present disclosure, wherein the preset pressure threshold may be set in a system or application of the mobile terminal. Upon determining the pressure threshold, a pressure corresponding to the press operation and applied to the application receiving an event notification may be judged whether to be greater than the preset pressure threshold; when the pressure corresponding to the press operation is greater than the preset pressure threshold, the press operation applied to the application receiving an event notification may be determined to satisfy the preset condition. The press operation satisfying the preset condition namely represents that the user wants to view the event notification of the application.

It should be noted that, when setting the preset pressure threshold, the user may calibrate a strength that can be induced by the display screen of the mobile terminal. Three pressure values may be preset in the mobile terminal, and the user is guided to press the display screen using three different pressures; when the preset pressure value is reached, successful calibration may be prompted, such that pressure thresholds set subsequently may be more accurate.

Moreover, the press operation may further be judged whether to satisfy the preset condition according to a duration corresponding to the press operation in another specific embodiment of the present disclosure. The user may determine a preset duration threshold corresponding to the press operation in the mobile terminal similarly. Upon determining the preset duration threshold, a duration corresponding to the press operation and applied to the application receiving an event notification may be judged whether to be greater than the preset duration threshold; when the duration corresponding to the press operation is greater than the preset duration threshold, the press operation applied to the application receiving an event notification may be determined to satisfy the preset condition. For example, when the user wants to view an event notification from WeChat, a press operation may be performed on a WeChat icon persistently for a certain period of time. When the persistent time reaches the preset duration threshold, then the mobile terminal judges that the press operation satisfies the preset condition, such that an application that the user wants to view may be known.

In step S4, when the press operation applied to the application receiving an event notification satisfies the preset condition, an interface of the application receiving an event notification is displayed in the second display region.

When judging that the press operation applied to the application receiving an event notification satisfies the preset condition, the interface of the application receiving an event notification may be displayed in the second display region. For example, when a plurality of applications all receives an event notification, icons of all the plurality of applications may be arranged in the second display region. At this moment, the user may perform a press operation on one application therein. When the mobile terminal judges that the press operation satisfies the preset condition, an application corresponding to the press operation may be acquired, such that a running interface of the application may be displayed in the second display region for the user to view.

In some embodiments of the present disclosure, the first display region and the second display region divided may have different sizes. For example, an area of the first display region may be greater than an area of the second display region possibly, such that the currently-running application may be presented to the user more clearly. In such a case, the application displayed in the second display region may not be too clear. In this way, when the user wants to view an event notification of the application in the second display region, the event notification may be not seen clearly since a typeface is too small. In view of this, a region exchanging step may be added in a specific embodiment of the present disclosure. When a press operation based on a terminal interface upon split-screen display is received, the press operation based on the terminal interface upon split-screen display may be judged whether to be a preset press operation in the embodiment of the present disclosure. For example, upon performing split-screen display, the mobile terminal receives continuous press operations appeared in the display screen, while the continuous press operations are preset as press operations special for region exchanging, then the mobile terminal may judge that the continuous press operations at this moment are preset press operations, and the continuous press operations are instructions for enabling region exchanging. In such a case, interfaces displayed in the first display region and in the second display region may be exchanged, such that the interface of the application receiving an event notification is displayed in the first display region so as to enable the user to view the event notification in the application clearly. Nevertheless, when the mobile terminal monitors the preset press operation again, the interfaces displayed in the first display region and in the second display region may be exchanged again.

Moreover, interfaces of two applications under split-screen display in the embodiment of the present disclosure are not activated all the time. Instead, only one display region can be activated in the same time, and only applications running in the display region can receive the touch instruction of the user. The touch instruction in the display screen of the mobile terminal may be monitored in the embodiment of the present disclosure, and a display region where the touch instruction belongs may be judged. For example, the mobile terminal monitors a click instruction applied to the display screen, then a display screen which the click instruction belongs may be judged according to a position of the click instruction. Upon judging the display region where the touch instruction belongs, the display region where the touch instruction belongs may be determined as a currently activated display region. An application in the currently activated display region is an application currently used by the user, and the user may give an instruction to the application.

After the user gives a split-screen cancellation instruction, the mobile terminal may extend the application displayed in the currently activated display region to the display screen of the mobile terminal in response to the split-screen cancellation instruction. In this way, an interface of the application currently used by the user may be extended to the entire display screen of the mobile terminal, such that the user can still use the application discontinuously upon the split-screen display is ended, which undoubtedly improves the use experience of the user.

As seen from the above, in the method for split-screen display according to the embodiment of the present disclosure, when the user receives an event notification of other application, the display screen of the mobile terminal may be divided into two display regions firstly according to a preset rule, then the application currently run in the mobile terminal may be displayed into one display region in the mobile terminal for the user to view continuously. Meanwhile, the application receiving an event notification may be displayed in another display region according to a press operation applied to the display screen by the user; in this way, the user is enabled to view the interface of the application receiving an event notification simultaneously in the case of keeping viewing the interface of the original application, such that application switching is avoided, and split-screen display steps are simple and convenient, such that the use experience of the user can be improved preferably. An application displayed in which display region and currently used by the user may be known by monitoring a touch instruction applied to the display screen by the user, such that a display region corresponding to the application may be determined as an activated display region. When the user gives a split-screen display cancellation instruction, an interface of the application in the activated display region may be extended to the entire display screen of the mobile terminal so as to provide discontinuous application use experience to the user.

An embodiment of the present disclosure further provides a split-screen display mobile terminal. FIG. 2 is a diagram illustrating functional modules of a mobile terminal for split-screen display according to the embodiment of the present disclosure. As illustrated in FIG. 2, the mobile terminal includes:

a region dividing module 100, configured to divide a display screen of a mobile terminal into a first display region and a second display region in response to a split-screen display instruction;

a first displaying module 200, configured to display an interface of a currently-running application in the first display region;

a press operation judging module 300, configured to judge whether a press operation applied to an application receiving an event notification satisfies a preset condition; and

a second displaying module 400, configured to, when the press operation applied to the application receiving an event notification satisfies the preset condition, display an interface of the application receiving an event notification in the second display region.

In one specific embodiment of the present disclosure, in addition to the region dividing module 100, the mobile terminal may further include:

a split-screen display setting module 000, configured to set a split-screen display mode of the display screen of the mobile terminal, the split-screen display mode including up and down split-screen display or left and right split-screen display.

In another specific embodiment of the present disclosure, the press operation judging module 300 specifically includes:

a pressure threshold determining module, configured to determine a preset pressure threshold corresponding to the press operation;

a pressure judging module, configured to judge whether a pressure corresponding to the press operation and applied to the application receiving an event notification is greater than the preset pressure threshold; and

a first determining module, configured to, when the pressure corresponding to the press operation is greater than the preset pressure threshold, determine that the press operation applied to the application receiving an event notification satisfies the preset condition.

In another specific embodiment of the present disclosure, the press operation judging module 300 specifically include:

a duration threshold determining module, configured to determine a preset duration threshold corresponding to the press operation;

a duration judging module, configured to judge whether a duration corresponding to the press operation and applied to the application receiving an event notification is greater than the preset duration threshold; and

a second determining module, configured to, when the duration corresponding to the press operation is greater than the preset duration threshold, determine that the press operation applied to the application receiving an event notification satisfies the preset condition.

In another specific embodiment of the present disclosure, in addition to the second displaying module 400, the mobile terminal further includes:

a press operation receiving module, configured to receive a press operation based on a terminal interface upon split-screen display;

a judging module, configured to judge whether the press operation based on the terminal interface upon split-screen display is a preset press operation; and

an interface exchanging module, configured to, when the press operation based on the terminal interface upon split-screen display is the preset press operation, exchange interfaces displayed in the first display region and in the second display region.

In another specific embodiment of the present disclosure, in addition to the second displaying module 400, the mobile terminal further includes:

a touch instruction monitoring module, configured to monitor a touch instruction on the display screen of the mobile terminal, and judge a display region where the touch instruction belongs; and

an activated region determining module, configured to determine the display region where the touch instruction belongs as a currently activated display region.

Wherein, in addition to the activated region determining module, the mobile terminal further includes:

a split-screen canceling module, configured to extend an interface of an application displayed in the currently activated display region to the display screen of the mobile terminal in response to a split-screen cancellation instruction.

It should be noted that the concrete implementation manner for each functional module above according to the foregoing embodiments of the present disclosure is consistent with that in steps S1 to S4, and will not be elaborated herein.

As seen from the above, in the split-screen display mobile terminal according to the embodiment of the present disclosure, when a user receives an event notification of other application, the display screen of the mobile terminal may be divided into two display regions firstly according to a preset rule, then the application currently run in the mobile terminal may be displayed into one display region in the mobile terminal for the user to view continuously. Meanwhile, the application receiving an event notification may be displayed in another display region according to a press operation applied to the display screen by the user; in this way, the user is enabled to view the interface of the application receiving an event notification simultaneously in the case of keeping viewing the interface of the original application, such that application switching is avoided, and split-screen display steps are simple and convenient, such that the use experience of the user can be improved preferably. An application displayed in which display region and currently used by the user may be known by monitoring a touch instruction applied to the display screen by the user, such that a display region corresponding to the application may be determined as an activated display region. When the user gives a split-screen display cancellation instruction, an interface of the application in the activated display region may be extended to the entire display screen of the mobile terminal so as to provide discontinuous application use experience to the user.

Embodiments of the present disclosure further provide a non-volatile computer-readable storage medium, the non-volatile computer-readable storage medium is stored with computer executable instructions which are configured to perform any of the embodiments described above of the method for split-screen display.

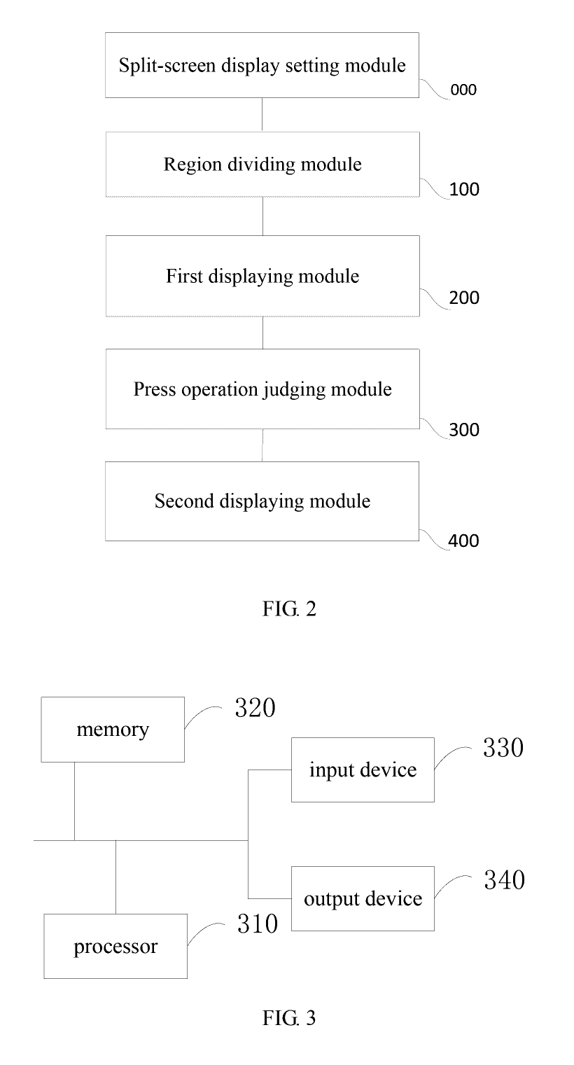

FIG. 3 is a schematic diagram of hardware structure of an electronic device used to perform the method for split-screen display according to an embodiment of the present disclosure, as shown in FIG. 4, the device includes:

One or more processors 310 and a memory 320, FIG. 3 illustrates one processor 310 as an example.

The device for the method for split-screen display may further include an input device 330 and an output device 340.

The processor 310, the memory 320, the input device 330 and the output device 340 may be connected with each other through bus or other forms of connections. FIG. 3 illustrates bus connection as an example.

As a non-volatile computer-readable storage medium, the memory 320 may be configured to store non-volatile software program, non-volatile computer executable program and modules, such as program instructions/modules corresponding to the method for split-screen display according to the embodiments of the disclosure (for example, the region dividing module 100, the first displaying module 200, the press operation judging module 300, the second displaying module 400, and the split-screen display setting module 000, as illustrated in FIG. 2). By executing the non-volatile software program, instructions and modules stored in the memory 320, the processor 310 may perform various functional applications of the server and data processing, that is, the method for split-screen display according to the above mentioned embodiments.

The memory 320 may include a program storage area and a data storage area, wherein, the program storage area may be stored with the operating system and applications which are needed by at least one functions, and the data storage area may be stored with data which is created according to use of the device for split-screen display. Further, the memory 320 may include a high-speed random access memory, and may further include non-volatile memory, such as at least one of disk memory device, flash memory device or other types of non-volatile solid state memory device. In some embodiments, optionally, the memory 320 may include memory provided remotely from the processor 310, and such remote memory may be connected with the device for split-screen display through network connections, the examples of the network connections may include but not limited to internet, intranet, LAN (Local Area Network), mobile communication network or combinations thereof.

The input device 330 may receive inputted number or character information, and generate key signal input related to the user settings and functional control of the device for split-screen display. The output device 340 may include a display device such as a display screen.

The above one or more modules may be stored in the memory 320, when these modules are executed by the one or more processors 310, the method for split-screen display according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smarttoys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for split-screen display, comprising:
at an electronic device;
dividing a display screen of a mobile terminal into a first display region and a second display region in response to a split-screen display instruction;
displaying an interface of a currently-running application in the first display region;
judging whether a press operation applied to an application receiving an event notification satisfies a preset condition; and
when the press operation applied to the application receiving an event notification satisfies the preset condition, displaying an interface of the application receiving an event notification in the second display region.

2. The method according to claim 1, wherein prior to the dividing a display screen of a mobile terminal into a first display region and a second display region in response to a split-screen display instruction, the method further comprises:
setting a split-screen display mode of the display screen of the mobile terminal, the split-screen display mode comprising up and down split-screen display or left and right split-screen display.

3. The method according to claim 1, wherein the judging whether a press operation applied to an application receiving an event notification satisfies a preset condition comprises:
determining a preset pressure threshold corresponding to the press operation;
judging whether a pressure corresponding to the press operation and applied to the application receiving an event notification is greater than the preset pressure threshold; and
when the pressure corresponding to the press operation is greater than the preset pressure threshold, determining that the press operation applied to the application receiving an event notification satisfies the preset condition.

4. The method according to claim 1, wherein the judging whether a press operation applied to an application receiving an event notification satisfies a preset condition comprises:
determining a preset duration threshold corresponding to the press operation;
judging whether a duration corresponding to the press operation and applied to the application receiving an event notification is greater than the preset duration threshold; and
when the duration corresponding to the press operation is greater than the preset duration threshold, determining that the press operation applied to the application receiving an event notification satisfies the preset condition.

5. The method according to claim 1, wherein after the step of displaying an interface of the application receiving an event notification in the second display region, the method further comprises:
receiving a press operation based on a terminal interface upon split-screen display;
judging whether the press operation based on the terminal interface upon split-screen display is a preset press operation; and
when the press operation based on the terminal interface upon split-screen display is the preset press operation, exchanging interfaces displayed in the first display region and in the second display region.

6. The method according to claim 1, wherein after the step of displaying an interface of the application receiving an event notification in the second display region, the method further comprises:
monitoring a touch instruction on the display screen of the mobile terminal, and judging a display region where the touch instruction belongs; and
determining the display region where the touch instruction belongs as a currently activated display region.

7. The method according to claim 6, wherein after the step of determining the display region where the touch instruction belongs as a currently activated display region, the method further comprises:
extending an interface of an application displayed in the currently activated display region to the display screen of the mobile terminal in response to a split-screen cancellation instruction.

8. An electronic device, comprising:
at least one processor; and
a memory communicably connected with the at least one processor for storing instructions executable by the at least one processor, wherein execution of the instructions by the at least one processor causes the at least one processor to:
divide a display screen of a mobile terminal into a first display region and a second display region in response to a split-screen display instruction;
display an interface of a currently-running application in the first display region;
judge whether a press operation applied to an application receiving an event notification satisfies a preset condition; and
when the press operation applied to the application receiving an event notification satisfies the preset condition, display an interface of the application receiving an event notification in the second display region.

9. The electronic device according to claim 8, wherein the step to judge whether a press operation applied to an application receiving an event notification satisfies a preset condition comprises:
determining a preset pressure threshold corresponding to the press operation;
judging whether a pressure corresponding to the press operation and applied to the application receiving an event notification is greater than the preset pressure threshold; and
when the pressure corresponding to the press operation is greater than the preset pressure threshold, determining that the press operation applied to the application receiving an event notification satisfies the preset condition.

10. The electronic device according to claim 8, wherein judge whether a press operation applied to an application receiving an event notification satisfies a preset condition comprises:
determine a preset duration threshold corresponding to the press operation;
judge whether a duration corresponding to the press operation and applied to the application receiving an event notification is greater than the preset duration threshold; and
when the duration corresponding to the press operation is greater than the preset duration threshold, determine that the press operation applied to the application receiving an event notification satisfies the preset condition.

11. A non-transitory computer-readable storage medium storing executable instructions that, when executed by an electronic device with a touch-sensitive display, cause the electronic device to:
divide a display screen of a mobile terminal into a first display region and a second display region in response to a split-screen display instruction;
display an interface of a currently-running application in the first display region;
judge whether a press operation applied to an application receiving an event notification satisfies a preset condition; and
when the press operation applied to the application receiving an event notification satisfies the preset condition, display an interface of the application receiving an event notification in the second display region.
